(19) United States
(12) Patent Application Publication
(10) Pub. No.: US 2005/0262880 A1
(43) Pub. Date: Dec. 1, 2005

(54) Washing machine

(75) Inventors: Seong No Yoon, Changwon-si (KR); Bong Sang Lee, Changwon-si (KR); Sung Rak Gong, Busan (KR); Bo Yeon Kim, Changwon-si (KR); Seong Yeol Lee, Daegu (KR); Dae Hee Kwon, Busan (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/034,772

(22) Filed: Jan. 14, 2005

(30) Foreign Application Priority Data
Jun. 1, 2004 (KR) P2004-39603

(51) Int. Cl. B08B 3/12

(52) U.S. Cl. 68/3 R; 68/232; 68/235 R

(57) ABSTRACT

Disclosed is a washing machine including a body, at least one leg provided on a bottom surface of the body so as to control horizontality, and a sloping part provided at a lower part of the body so as to prevent a foot of a user from being caught in a space under the bottom surface thereof.

### CROSS-REFERENCE TO RELATED APPLICATIONS

This application claims the benefit of Korean Application No. P2004-39603, filed on Jun. 1, 2004, which is hereby incorporated by reference as if fully set forth herein.

### BACKGROUND OF THE INVENTION

1. Field of the Invention

The present invention relates to a washing machine, and more particularly, to a washing machine having an easy-to-use structure.

2. Discussion of the Related Art

In general, a washing machine is an apparatus for washing laundries by using an emulsification function of detergent, or friction with a current according to the rotation of a pulsator or a drum.

In recent years, a drum washing machine is gradually increasing, the drum washing machine having a lower height than a pulsator washing machine and preventing wrinkles from occurring on laundries.

FIG. 1 illustrates a perspective view showing an exterior of a conventional washing machine. As illustrated in FIG. 1, the washing machine includes a body 10, a plurality of leg 40 and a control panel.

The body 10 includes an exterior of the washing machine, and the plurality of leg 40 is provided at an edge of a bottom surface of the body 10 so as to control the balance of the washing machine and supporting the body 10.

A front cover 50 is provided on a front surface of the body 10, and a door 50 is provided on a front cover 50 so as to throw in laundries into the drum.

A control panel 20 is provided at an upper part of the door 50 so as to control the washing machine and to display operating conditions.

Although not illustrated, the body includes a tub for accommodating laundries, a drum rotatably provided for accommodating laundries in the tub, and a motor for rotating the drum.

FIG. 2 illustrates a diagram showing a diagram showing a bottom structure of a front cover of a washing machine in accordance with a related art. As illustrated in FIG. 2, in the washing machine in accordance with the present invention, bottom of front surfaces of the front cover 11 lie at right angles to each other. Since the plurality of legs are provided on a bottom surface of the washing machine so as to control the horizontality thereof, a predetermined space is formed between a floor of a location where the washing machines is placed and a bottom surface of the cover. A depth between a front surface of the front cover and the legs under the front part of the body is about L1.

Accordingly, there is a problem that a foot of a user is easily caught between the bottom surface of the front cover 11, and it is difficult to take out the foot because the foot is caught by a bottom end of the front cover and the floor.

Particularly, there is another problem that a user is injured when the foot of the user is hit against a lower corner lying at right angles of the front cover.

### SUMMARY OF THE INVENTION

Accordingly, the present invention is directed to a washing machine that substantially obviates one or more problems due to limitations and disadvantages of the related art.

An object of the present invention is to provide a washing machine having an easy-to-use structure.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a washing machine includes a body; at least one leg provided on a bottom surface of the body so as to control horizontality; and a sloping part provided at a lower part of the body so as to prevent a foot of a user from being caught in a space under the bottom surface thereof.

The sloping part declines inward from a front lower part of the body of the washing machine. The sloping part declines inward from both sides of the body of the washing machine. The sloping part declines inward from a lower corner of the body of the washing machine.

The washing machine comprises a front panel on a front surface thereof, and the sloping part is provided at a lower part of the front panel.

In another aspect of the present invention, a washing machine comprises a body; at least one leg provided on a bottom surface of the body so as to control horizontality; and a recess part provided at a lower part of the body so as to prevent a foot of a user from being caught in a space under the bottom surface thereof.

The recess part is provided at a front lower surface of the body and inwardly formed in a step shape. The recess part is provided at both lower sides of the body and inwardly formed in a step shape. The recess part is provided at a lower corner of the body and inwardly formed in a step shape.

A front surface of the washing machine comprises a front panel, and the recess part is provided at a lower part of the front panel.

In another aspect of the present invention, a washing machine comprising: a body; at least one leg provided on a bottom surface of the body so as to control horizontality; and a round part provided at a lower part of the body so as to prevent a foot of a user from being caught in a space under the bottom surface thereof.

In this case, the round part is formed to be rounded inward from a lower front surface of the body. The round part is rounded inward from both lower sides of the body. The round part is rounded inward from a lower corner of the body.

The body comprises a front panel on a front surface thereof, and the round part is provided at a lower part of the front panel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view showing an exterior of a conventional washing machine;

FIG. 2 illustrates a lateral view showing a bottom structure of a drum type washing machine in accordance with a related art;

FIG. 3 illustrates lateral view showing a bottom structure of a washing machine having a sloping part, in accordance with the present invention;

FIG. 4 illustrates a lateral view showing a bottom structure of a washing machine having a recess part, in accordance with the present invention; and

FIG. 5 illustrates a lateral view showing a bottom structure of a washing machine having a round part, in accordance with a third embodiment of the present invention.

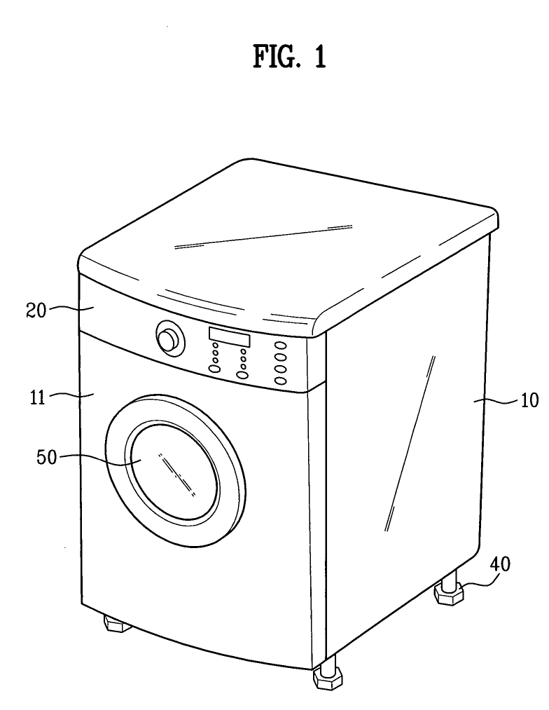

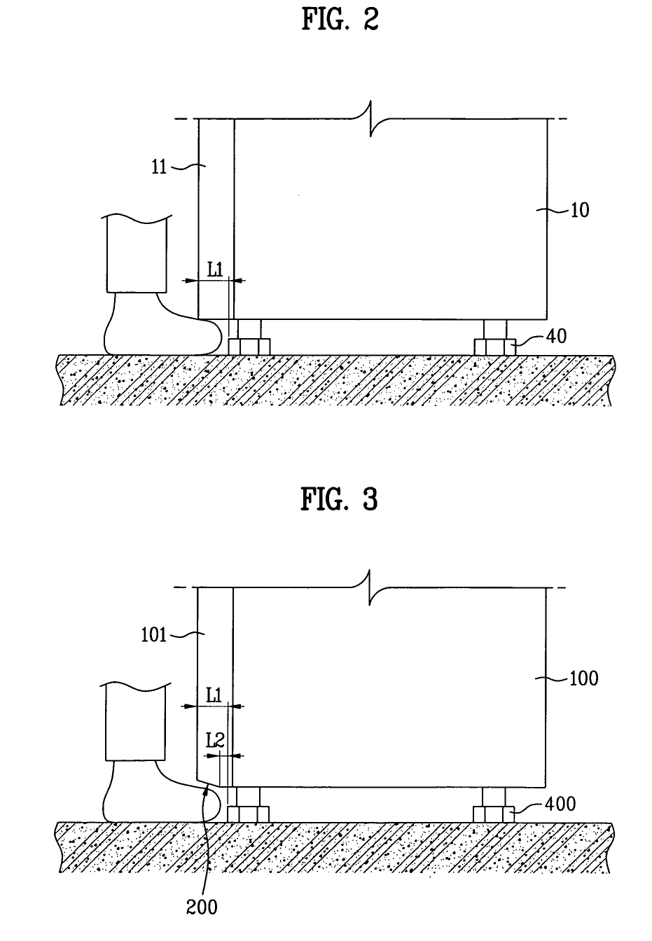

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a washing machine in accordance with preferred embodiments of the present invention will be described referring to appended drawings. FIG. 3 illustrates lateral view showing a bottom structure of a washing machine having a sloping part, in accordance with the present invention. As shown in FIG. 3, at least one leg 400 for controlling the horizontality of the washing machine is provided on a bottom surface of a body 100 of the washing machine. Preferably, the plurality of legs 400 are respectively provided at each edge on the bottom surface of the body, each leg being capable of controlling the height thereof.

In this case, a space having predetermined height is formed between a floor where the washing machine is placed and a bottom surface of the body 100 of the washing machine.

Meanwhile, in order to prevent a foot of a user from being caught in the space, a sloping part 200 is provided at a lower part of the body 100. The sloping part 200 declines inward from a front surface of body 100 or a lower part of both sides thereof. Accordingly, the foot of the user is prevented from being inserted into the lower part of the body 100, thereby improving safety of the washing machine.

In this case, when the front surface of the washing machine includes a front cover 101 which is a separate part, the sloping part 200 is formed at a lower part of the front cover 101. In addition, it is desirable that the sloping part 200 be formed to be large enough to receive a foot of an average adult.

Usability of the sloping part in accordance with a first embodiment of the present invention will be described as follows. Even though a foot of a user is entered into a space between the bottom surface of the body 10 and the floor of a washing room when a user operates the washing machine, standing in front of the washing machine, the foot is prevented from being caught therein due to the sloping part 200 provided at a front portion of the body 100 or the lower part of the front cover 101.

In more detail, when sloping part 200 is provided, the depth of the space thereunder is L1. On the other hand, when the sloping part 200 is not provided, the depth is shortened and becomes about L2.

Accordingly, the foot entered into the lower part of the body 100 can be smoothly taken out.

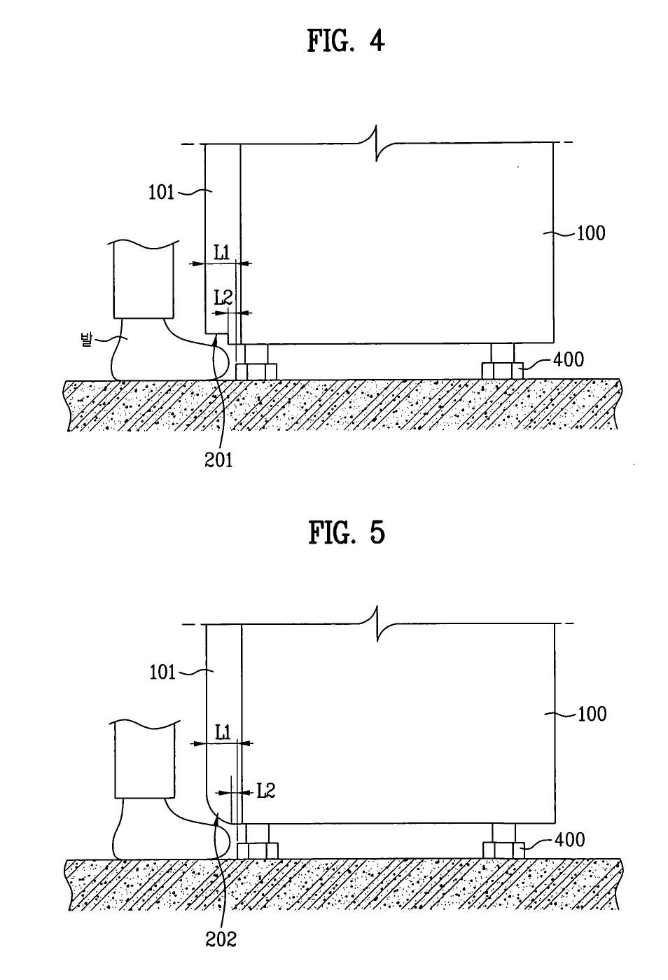

FIG. 4 illustrates a lateral view showing a bottom structure of a washing machine having a recess part, in accordance With the present invention. As illustrated in FIG. 4, the recess part 201 is provided at a lower part of the body 100. The recess part 201 is formed at a lower part of the front surface or both sides of the body 100. The recess part 201 is formed to have different heights at only a lower corner of the body 100. Accordingly, the foot of the user is prevented from being caught in a lower part of the body 100, and thus the safety of the washing machine is increased.

In this case, when the front surface of the body 100 of the washing machine includes a front cover 101 which is a separate part, the recess part 201 is formed at a lower part of the front cover 101. In addition, it is desirable that the recess part 201 be formed to be large enough such that a foot of an average adult may be entered into under the recess part 201.

Usability of the recess part 201 in accordance with a second embodiment of the present invention will be described as follows. Even though a foot of a user is entered into a space between the bottom surface of the body 10 and the floor of a washing room when a user operates the washing machine, standing in front of the washing machine, the foot is prevented from being caught therein due to the recess part 201 provided at a front portion of the body 100 or the lower part of the front cover 101.

In more detail, when sloping part 200 is provided, the depth of the space thereunder is L1. On the other hand, when the sloping part 200 is not provided, the depth is shortened and becomes about L2.

Accordingly, the foot entered into the lower part of the body 100 can be smoothly taken out.

FIG. 5 illustrates a lateral view showing a bottom structure of a washing machine having a round part, in accordance with a third embodiment of the present invention. As illustrated in FIG. 5, a round part 202 is provided at a lower part of the body 100. The round part 202 is formed to be rounded inward from an upper part thereof to a lower part thereof.

The round part 202 is formed to be rounded inward from a lower front surface of the body or from both lower sides of the body. The round part may be rounded inward only from a lower corner of the body. Accordingly, the foot of the user is prevented from being caught in the lower part of the body 100, and thus the safety of the washing machine is increased.

In this case, when the front surface of the washing machine includes a front cover 101 which is a separate part, the round part 202 is formed at a lower part of the front cover 101.

As mentioned above, the washing machine in accordance with the present invention has effects as follows.

First, in order to prevent a foot of a user from being caught in a space between a bottom surface of the front cover and a floor, a sloping part, a recess part, and a round part are formed at a lower part of the body or the front cover. Accordingly, the foot of the user is prevented from being caught in a lower part of the body of the washing machine.

Second, since the sloping part, the recess part, and the round part are formed at the lower part of the front cover, the foot of the user is prevented from being injured by hitting against a lower corner of the front cover.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A washing machine, comprising:
a body;
at least one leg provided on a bottom surface of the body so as to control horizontality; and
a sloping part provided at a lower portion of the body so as to prevent a foot of a user from being caught in a space under the bottom surface thereof.

2. The washing machine of claim 1, wherein the sloping part declines inward from a front lower portion of the body of the washing machine.

3. The washing machine of claim 1, wherein the sloping part declines inward from both sides of the body of the washing machine.

4. The washing machine of claim 1, wherein the sloping part declines inward from a lower corner of the body of the washing machine.

5. The washing machine of claim 1, wherein the body further comprises a front panel on a front surface thereof, and the sloping part is provided at a lower portion of the front panel.

6. A washing machine, comprising:
a body;
at least one leg provided on a bottom surface of the body so as to control horizontality; and
a recess part provided at a lower portion of the body so as to prevent a foot of a user from being caught in a space under the bottom surface thereof.

7. The washing machine of claim 6, wherein the recess part is provided at a front lower surface of the body and inwardly formed in a step shape.

8. The washing machine of claim 6, wherein the recess part is provided at both lower sides of the body and inwardly formed in a step shape.

9. The washing machine of claim 6, wherein the recess part is provided at a lower corner of the body and inwardly formed in a step shape.

10. The washing machine of claim 6, wherein the body further comprises a front panel on a front surface thereof, and the recess part is provided at a lower portion of the front panel.

11. A washing machine comprising:
a body;
at least one leg provided on a bottom surface of the body so as to control horizontality; and
a round part provided at a lower portion of the body so as to prevent a foot of a user from being caught in a space under the bottom surface thereof.

12. The washing machine of claim 11, wherein the round part is formed to be rounded inward from a lower front surface of the body.

13. The washing machine of claim 11, wherein the round part is rounded inward from both lower sides of the body.

14. The washing machine of claim 11, wherein the round part is rounded inward from a lower corner of the body.

15. The washing machine of claim 11, wherein the body further comprises a front panel on a front surface thereof, and the round part is provided at a lower portion of the front panel.
